(19) United States
(12) Patent Application Publication
(10) Pub. No.: US 2011/0227844 A1
(43) Pub. Date: Sep. 22, 2011

(54) METHOD AND APPARATUS FOR INPUTTING CHARACTER IN PORTABLE TERMINAL

(75) Inventor: Dae-Young KIM, Seoul (KR)

(73) Assignee: SAMSUNG ELECTRONICS CO. LTD., Suwon-si (KR)

(21) Appl. No.: 13/045,849

(22) Filed: Mar. 11, 2011

(30) Foreign Application Priority Data
Mar. 17, 2010 (KR) 10-2010-0023601

(51) Int. Cl. G06F 3/041

(52) U.S. Cl. 345/173

(57) ABSTRACT

A method and apparatus for inputting a character in a portable terminal are provided. A method for inputting a character in a portable terminal includes displaying a keypad on a screen, detecting a screen touch, determining whether the screen touch moves based on a start position and an end position of the screen touch, and displaying a character corresponding to a touch position or performing a character input function corresponding to a touch movement direction, according to whether the screen touch is determined to move.

### PRIORITY

This application claims the benefit under 35 U.S.C. §119(a) of a Korean patent application filed in the Korean Intellectual Property Office on Mar. 17, 2010 and assigned Serial No. 10-2010-0023601, the entire disclosure of which is hereby incorporated by reference.

### BACKGROUND OF THE INVENTION

1. Field of the Invention

The present invention relates to a method and apparatus for inputting a character in a portable terminal. More particularly, the present invention relates to a method and apparatus for inputting a character in a portable terminal supporting a touchscreen.

2. Description of the Related Art

Users of portable terminals are increasingly utilizing message-related functions (e.g., short messages, multimedia messages, e-mails, and broadcast messages) over a call function. As a result, character input into portable terminals is increasingly being performed. Accordingly, techniques for efficient character input are being developed.

In addition, the use of touchscreen portable terminals has rapidly increased in recent years. Accordingly, techniques for efficient touchscreen-based character input are being developed. For example, a 3×4 alphanumeric keypad or a full-screen QWERTY keypad is displayed on a touchscreen to input a numeral or character corresponding to the position of a touch of the user.

For the purposes of miniaturization and design, touchscreen portable terminals may not have up/down/left/right navigation (or direction) keys. However, since the navigation keys generally serve as Space/Delete/Enter keys for intuitive character input, portable terminals should be provided with the navigation keys.

FIG. 1 is a diagram illustrating a keypad configuration for character input in a conventional touchscreen portable terminal.

Referring to FIG. 1, a conventional portable terminal displays navigation keys or Space/Delete/Enter keys in addition to an alphanumeric keypad or a full-screen QWERTY keypad to enable the user to more intuitively input characters.

However, displaying navigation keys or other keys in addition to the conventional keypad occupies a large display region on a screen of a portable terminal.

Also, in the case of the alphanumeric keypad, because a plurality of characters or numerals are mapped to each key region, if characters or numerals mapped to the same key region are to be successively inputted, the user may be inconvenienced by having to input the navigation keys. Also, in the case of a portable terminal using the alphanumeric keypad, the user may be inconvenienced because some of the navigation keys are omitted or because a function key such as an Enter key is accessible through another menu.

### SUMMARY OF THE INVENTION

An aspect of the present invention is to address at least the above-mentioned problems and/or disadvantages and to provide at least the advantages described below. Accordingly, an aspect of the present invention is to provide a method and apparatus for inputting characters in a portable terminal by using a touchscreen.

Another object of the present invention is to provide a method and apparatus for performing a mapped character input function according to the touch direction of a user while inputting characters by displaying a keypad on a touchscreen in a portable terminal.

In accordance with an aspect of the present invention, a method for inputting a character in a portable terminal is provided. The method includes displaying a keypad on a screen, detecting a screen touch, determining whether the screen touch moves based on a start position and an end position of the screen touch, and displaying a character corresponding to a touch position or performing a character input function corresponding to a touch movement direction, according to whether the screen touch is determined to move.

According to another aspect of the present invention, an apparatus for inputting a character in a portable terminal is provided. The method includes a display unit for displaying a keypad on a screen, an input unit for detecting a screen touch, and a control unit for determining whether the screen touch moves based on a start position and an end position of the screen touch, and for displaying a character corresponding to a touch position or performing a character input function corresponding to a touch movement direction, according to whether the screen touch is determined to move.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a diagram illustrating a keypad configuration for character input in a conventional touchscreen portable terminal;

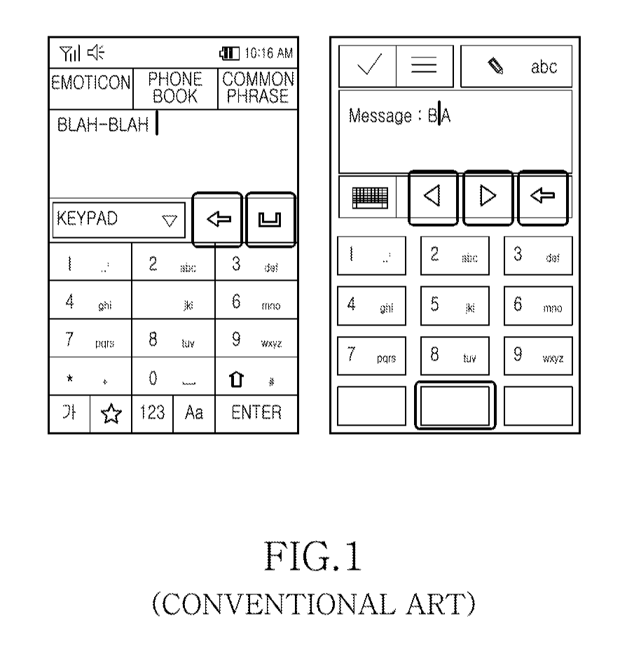

FIG. 2 is a block diagram of a touchscreen portable terminal according to an exemplary embodiment of the present invention;

FIG. 3 is a flow diagram illustrating a character input process in a portable terminal according to an exemplary embodiment of the present invention; and

FIGS. 4A to 4C are diagrams illustrating a character input method in a portable terminal according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention provide a method and apparatus for performing a mapped character input function according to the touch direction of a user while inputting characters by displaying a keypad on a touchscreen in a portable terminal.

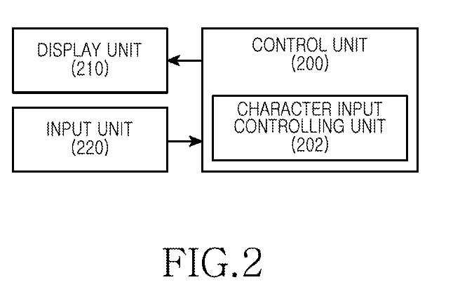

FIG. 2 is a block diagram of a touchscreen portable terminal according to an exemplary embodiment of the present invention.

Referring to FIG. 2, the portable terminal includes a control unit 200, a display unit 210, and an input unit 220. The control unit 200 includes a character input controlling unit 202.

The control unit 200 controls an overall operation of the portable terminal. According to an exemplary embodiment of the present invention, the control unit 200 includes the character input controlling unit 202 to detect the position and determine the movement direction of a touch of a user and control a character input function. When executing a character input application, the character input controlling unit 202 controls the display unit 210 to display a keypad, and detects a screen touch motion (i.e., a touch position and a touch movement direction) of the user through the input unit 220 to control a character input function corresponding to the result of the detection. If the start position and the end position of a touch of the user are identical, the character input controlling unit 202 determines whether the position corresponds to a predefined key region of the displayed keypad. If the position corresponds to a predefined key region of the displayed keypad, the character input controlling unit 202 controls a function for inputting a character mapped to the predefined key and displaying the character on the display unit 210. On the other hand, if the start position and the end position of a touch of the user are different, the character input controlling unit 202 determines the movement direction of the touch and performs a character input function corresponding to the touch movement direction.

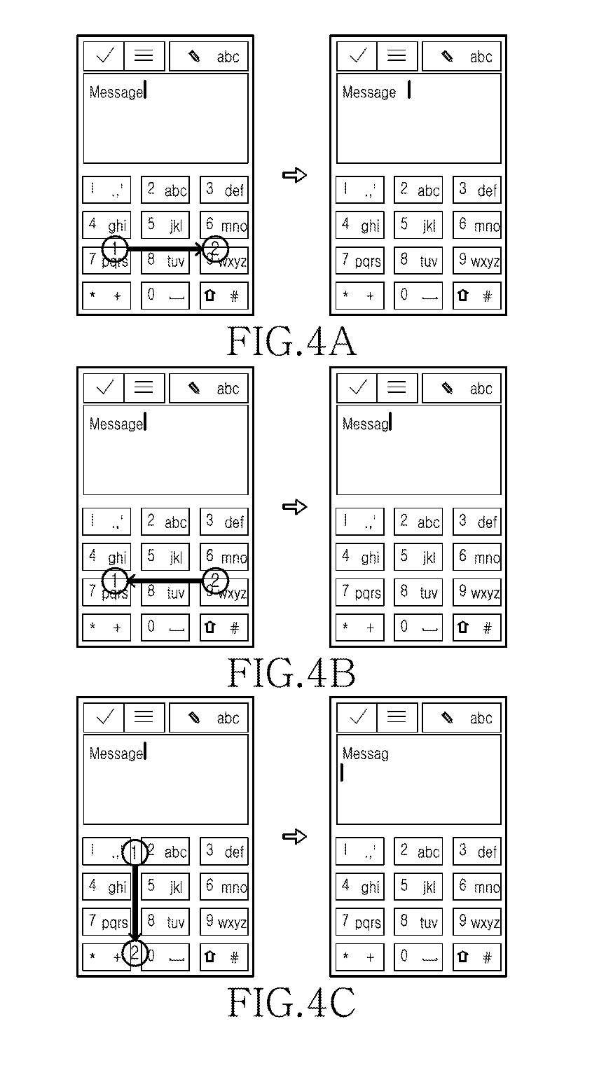

FIGS. 4A to 4C are diagrams illustrating a character input method in a portable terminal according to an exemplary embodiment of the present invention.

Referring to FIG. 4A, if a touch of the user moves to the right, the character input controlling unit 202 performs a Space function (or a space bar function). Referring to FIG. 4B, if a touch of the user moves to the left, the character input controlling unit 202 performs a function of deleting an inputted character. Referring to FIG. 4C, if a touch of the user moves downward, the character input controlling unit 202 performs an Enter Key function, that is, a paragraph change function. Also, if a touch of the user moves upward, the character input controlling unit 202 performs a function of moving a cursor, which represents a character input position, to the upper line.

The display unit 210 displays numerals and characters, pictures and status information generated during an operation of the portable terminal. Under the control of the control unit 200, the display unit 210 displays characters corresponding to the touch motions of the user in a character input mode. For example, referring again to FIG. 4A, if a touch of the user moves to the right, the display unit 210 moves a cursor by one column to the right to enable the user to detect the execution of a Space function. Referring again to FIG. 4B, if a touch of the user moves to the left, the display unit 210 deletes a displayed character preceding the cursor. Referring again to FIG. 4C, if a touch of the user moves downward, the display unit 210 moves the cursor and the character position following the cursor to the next line to enable the user to detect the execution of an Enter function, that is, a paragraph change function.

The input unit 220 includes at least one of a keypad that includes at least one of a function key, a numeral key and a character key, and a touch sensor that detects a motion of touching the screen of the display unit 210. The input unit 220 provides the control unit 200 with the coordinates of a touch position or the data corresponding to a key pressed by the user.

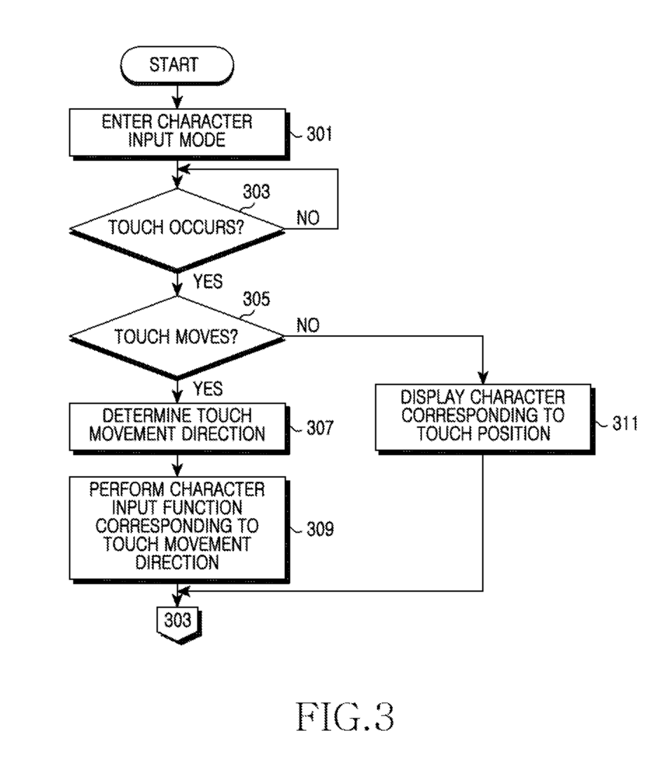

FIG. 3 is a flow diagram illustrating a character input process in a portable terminal according to an exemplary embodiment of the present invention.

Referring to FIG. 3, in step 301, the portable terminal enters a character input mode and displays a keypad in a predefined region of a screen.

In step 303, the portable terminal determines whether a touch occurs. If a touch is determined to occur at step 303, the portable terminal proceeds to step 305. In step 305, the portable terminal determines whether the touch moves. That is, the portable terminal determines whether the touch ends without moving from the touch start position to another position or ends after moving from the touch start position to another position.

If the touch is not determined move at step 305, the portable terminal proceeds to step 311. In step 311, the portable terminal displays a character corresponding to the touch position. Herein, the touch position may not be in a keypad region. Therefore, the portable terminal may determine whether the touch position corresponds to a key region of the keypad displayed on the screen, and may input and display a character mapped to the key region if the touch position corresponds to the key region. If the touch position does not correspond to the key region but corresponds to a character display region, the portable terminal may move a cursor to the touch position or may not perform any operation.

On the other hand, if the touch is determined to move at step 305, the portable terminal proceeds to step 307. In step 307, the portable terminal determines the movement direction of the touch. Herein, the movement direction of the touch may be determined using the coordinates of the touch start position and the coordinates of the touch end position.

In step 309, the portable terminal performs a character input function corresponding to the touch movement direction. For example, referring again to FIG. 4A, if the touch moves to the right, the portable terminal performs a Space function (or a space bar function). Referring again to FIG. 4B, if the touch moves to the left, the portable terminal performs a function of deleting an inputted character. Referring again to FIG. 4C, if the touch moves downward, the portable terminal performs an Enter Key function, that is, a function of changing a paragraph to shift to the next line. Also, if the touch moves upward, the portable terminal performs a function of moving a cursor to the upper line. Herein, the character input function corresponding to the touch movement direction may be set and altered by the designer or user.

Thereafter, the portable terminal returns to step 303.

As described above, exemplary embodiments of the present invention display a keypad on a screen of a portable terminal supporting a touch sensor, detect the position of a touch of the user, and perform a function corresponding to the touch movement direction if the touch of the user moves while inputting a character corresponding to the touch position. Accordingly, exemplary embodiments of the present invention may effectively input characters without displaying additional navigation keys or additional function keys on the screen, and may reduce the occupation area of the character input keypad on the screen.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for inputting a character in a portable terminal, the method comprising:
displaying a keypad on a screen;
detecting a screen touch;
determining whether the screen touch moves based on a start position and an end position of the screen touch; and
displaying a character corresponding to a touch position or performing a character input function corresponding to a touch movement direction, according to whether the screen touch is determined to move.

2. The method of claim 1, wherein the character input function corresponding to the touch movement direction includes at least one of a space function, a delete function, a paragraph changing function, and a cursor moving function.

3. The method of claim 1, wherein the displaying of the character corresponding to the touch position or the performing of the character input function corresponding to the touch movement direction, according to whether the screen touch is determined to move, comprises:
performing a character input function corresponding to the touch movement direction if the screen touch is determined to move;
determining whether the touch position corresponds to a predefined region of the keypad, if the screen touch is not determined to move; and
displaying a character mapped to the predefined region, if the touch position corresponds to the predefined region of the keypad.

4. The method of claim 3, further comprising moving a cursor to the touch position if the touch position does not correspond to the predefined region of the keypad.

5. The method of claim 1, further comprising, if the screen touch is determined to move, determining the touch movement direction.

6. The method of claim 5, wherein the performing of the character input function corresponding to the touch movement direction comprises performing a space function if the screen touch is determined to move to the right.

7. The method of claim 5, wherein the performing of the character input function corresponding to the touch movement direction comprises performing a delete function if the screen touch is determined to move to the left.

8. The method of claim 5, wherein the performing of the character input function corresponding to the touch movement direction comprises performing a paragraph changing function if the screen touch is determined to move downward.

9. The method of claim 5, wherein the performing of the character input function corresponding to the touch movement direction comprises performing a cursor moving function if the screen touch is determined to move upward.

10. An apparatus for inputting a character in a portable terminal, the apparatus comprising:
a display unit for displaying a keypad on a screen;
an input unit for detecting a screen touch; and
a control unit for determining whether the screen touch moves based on a start position and an end position of the screen touch, and for displaying a character corresponding to a touch position or performing a character input function corresponding to a touch movement direction, according to whether the screen touch is determined to move.

11. The apparatus of claim 10, wherein the character input function corresponding to the touch movement direction includes at least one of a space function, a delete function, a paragraph changing function, and a cursor moving function.

12. The apparatus of claim 11, wherein the control unit performs a character input function corresponding to the touch movement direction if the screen touch is determined to move, determines whether the touch position corresponds to a predefined region of the keypad, if the screen touch is not determined to move, and displays a character mapped to the predefined region, if the touch position corresponds to the predefined region of the keypad.

13. The apparatus of claim 12, wherein the control unit performs a control function for moving a cursor to the touch position, if the touch position does not correspond to the predefined region of the keypad.

14. The apparatus of claim 10, wherein the control unit determines the touch movement direction, if the screen touch is determined to move.

15. The apparatus of claim 14, wherein the control unit performs a space function if the screen touch is determined to move to the right.

16. The apparatus of claim 14, wherein the control unit performs a delete function if the screen touch is determined to move to the left.

17. The apparatus of claim 14, wherein the control unit performs a paragraph changing function if the screen touch is determined to move downward.

18. The apparatus of claim 14, wherein the control unit performs a cursor moving function if the screen touch is determined to move upward.
